(19) United States
(12) Patent Application Publication
(10) Pub. No.: US 2011/0226921 A1
(43) Pub. Date: Sep. 22, 2011

(54) SYSTEM AND METHOD FOR SECURING A RODENT CONTROL DEVICE

(75) Inventor: Cecil E. Patterson, Jackson, GA (US)

(73) Assignee: B&G EQUIPMENT COMPANY, Jackson, GA (US)

(21) Appl. No.: 13/024,909

(22) Filed: Feb. 10, 2011

Related U.S. Application Data
(60) Provisional application No. 61/316,171, filed on Mar. 22, 2010.

(51) Int. Cl. A01M 99/00; F16M 13/00

(52) U.S. Cl. 248/346.03; 43/1

(57) ABSTRACT

The present invention comprises, in one exemplary embodiment, a rodent control device including a clamp system comprised of first and second clamp assemblies, and a rodent bait station having at least one opening formed therein for receiving an attachment device such as a screw. The first clamp assembly preferably includes a raised area having one or more openings formed therein for receiving the attachment device. The attachment device operates to secure the rodent bait station to the clamp system, which is in turn, secured to a weighted object such as a cement block. The clamp system substantially prevents movement of the rodent bait station by attaching the bait station to the weighted object.

### CROSS-REFERENCE TO RELATED APPLICATIONS

This application claims priority to U.S. Provisional Patent Application No. 61/316,171, entitled “System And. Method For Securing A Rodent Trap,” filed on Mar. 22, 2010, the entire contents of which are incorporated by reference, as if fully set forth herein.

### TECHNICAL FIELD

The disclosure relates generally to a rodent control device, and more particularly to a system and method for securing a rodent control device to a weighted object such as a concrete block.

### BACKGROUND

When placing a rodent control device on the exterior or interior of a building or structure, it is quite common to secure the device to the ground, or to secure the device to a pad or block. The reason for this is to help prevent the rodent control device from moving from its original position. With the use of the block or pad, it adds weight to the device and makes it much more difficult to move. Typically, this block will be constructed of concrete or other dense or weighted material.

There are two conventional methods for attaching a rodent control device to a block or pad. The first way is to drill into the block or pad, insert some sort of anchor, and then attach the rodent control device to this anchor. The second way is to attach the rodent control device to the block by use of an adhesive (e.g., glue, etc). Both ways have significant drawbacks. With the anchor procedure, there is the need to drill into the block or pad. Drilling into concrete is often difficult and frequently does not produce an appropriate size opening due to the brittle nature of concrete. With the adhesive procedure, if the block or pad became damaged, the rodent control device could not be removed, and often times the entire assembly (i.e., block and rodent control device) must be discarded.

Accordingly, there is presently a need for an efficient and effective system and method for securing a rodent control device to a weighted structure (such as a concrete block) which substantially prohibits movement of the trap, but which is relatively easy to install and remove.

### SUMMARY

An exemplary embodiment of the present invention comprises a rodent control device including a clamp system comprised of first and second clamp assemblies and a rodent bait station having at least one opening formed therein for receiving an attachment device, wherein the first clamp assembly of the clamp system includes a raised area having one or more openings formed therein for receiving the attachment device.

Another exemplary embodiment of the present invention comprises a clamp system including a first clamp assembly and a second clamp assembly, wherein the first clamp assembly includes a raised area having one or more openings formed therein for receiving an attachment device.

Yet another exemplary embodiment of the present invention comprises a method for monitoring rodent activity including the steps of attaching a clamp system to a block, attaching the clamp system and block to a rodent bait station, and periodically observing the rodent bait station to determine if rodent activity has occurred.

### BRIEF DESCRIPTION OF THE DRAWINGS

The invention will be better understood with reference to the following detailed description, of which the following drawings form an integral part.

FIG. 1 is an overhead perspective view of a clamp system for a rodent control device according to an exemplary embodiment.

FIG. 2 is left side perspective view of the clamp system of FIG. 1.

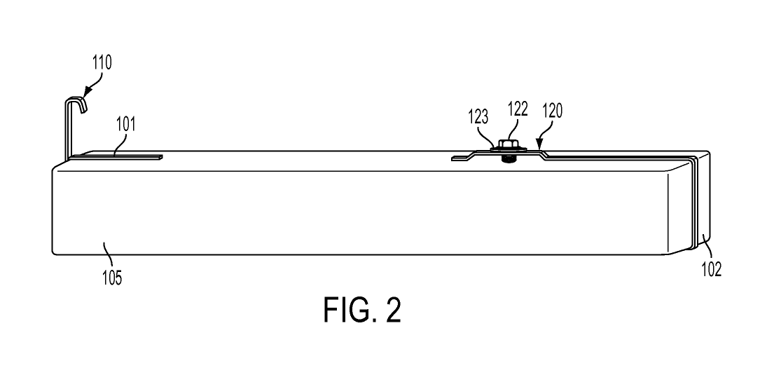

FIG. 3 is an overhead perspective view of a rodent control device, showing the cover removed.

FIG. 4 is a partially exploded perspective view of the rodent control device of FIG. 3.

FIG. 5 is a side elevation view of the rodent control device of FIG. 3.

FIG. 6 is a top view of the rodent control device of FIG. 3.

FIGS. 7(a)-7(b) are side elevation and perspective views of a first clamp assembly of the clamp system of FIG. 1.

FIGS. 8(a)-8(c) are perspective, side elevation and top views of a second clamp assembly of the clamp system of FIG. 1.

FIG. 9 is a side elevation view of the clamp system of FIG. 1, with the clamp assemblies removed from the block.

FIG. 10 is a side elevation view of the clamp system of FIG. 1, with the clamp assemblies partially inserted over the block.

FIG. 11 is a side elevation view of the clamp system of FIG. 1, with the clamp assemblies completely inserted over the block.

FIG. 12 is a left side perspective view of the rodent control device of FIG. 3, with the rodent bait station in a first, partially inserted, position.

FIG. 13 is a left side perspective view of the rodent control device of FIG. 3, with the rodent bait station in a second, partially inserted, position.

FIG. 14 is a side elevation view of the rodent control device of FIG. 3, with the rodent bait station in a second, partially inserted, position.

FIG. 15 is a side elevation view of the rodent control device of FIG. 3, with the rodent bait station in a third, fully inserted, position.

FIG. 16 is a partially exploded perspective view of the rodent control device of FIG. 3, showing an attachment device in a first, partially inserted, position.

FIG. 17 is a partially exploded perspective view of the rodent control device of FIG. 3, showing an attachment device in a second, partially inserted, position.

FIG. 18 is a partially exploded perspective view of the rodent control device of FIG. 3, showing an attachment device in a third, fully inserted, position.

### DETAILED DESCRIPTION

The present invention relates to a rodent control device including a means for securing the trap to a block or other environmental element (e.g., wall, floor, etc.). In the exemplary embodiment shown in the attached drawings, the means for securing comprises a clamp system, but those of ordinary skill in the art will realize that various means for securing may be utilized without departing from the scope of the present invention.

According to an exemplary embodiment of the present invention, a clamp system comprised of at least two ‘open box’ type clamp assemblies may be utilized to secure a rodent bait station to a pad or block. In the exemplary embodiment, one of the clamp assemblies would be coupled to a first (e.g., front) portion of the rodent bait station, and the other clamp assembly would be coupled to a second (e.g., rear) portion of the rodent bait station.

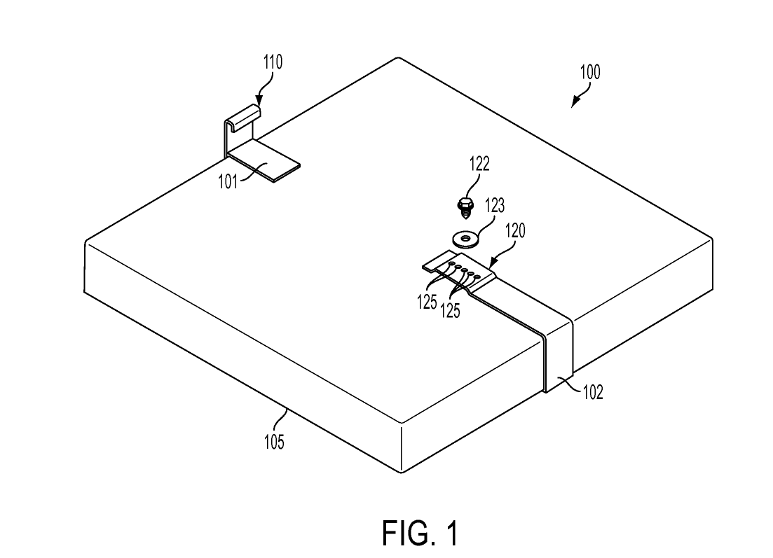

FIG. 1 shows some details of an exemplary clamp system 100. The clamp system 100 includes a first clamp assembly 101, and a second clamp assembly 102. Each of the clamp assemblies 101, 102 may be coupled to different portions of a block 105. As noted above, the block 105 may comprise a block of solid construction, such as a cement block.

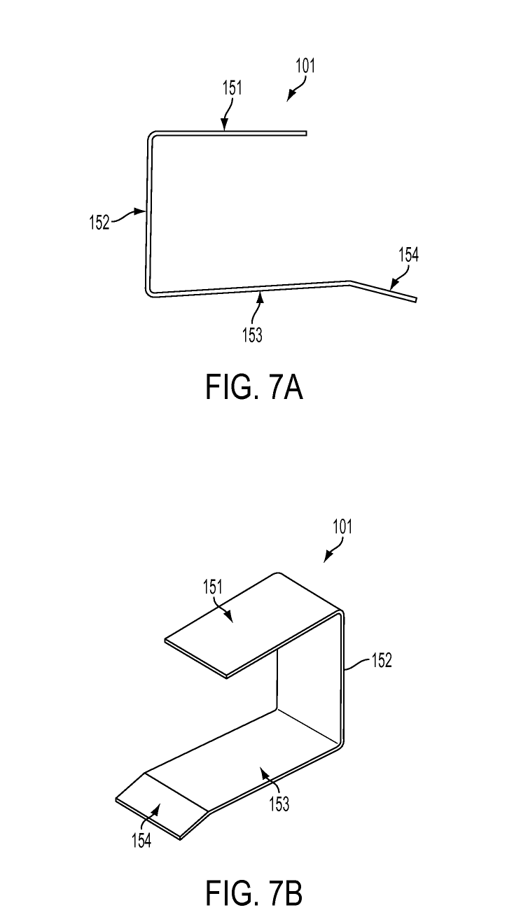

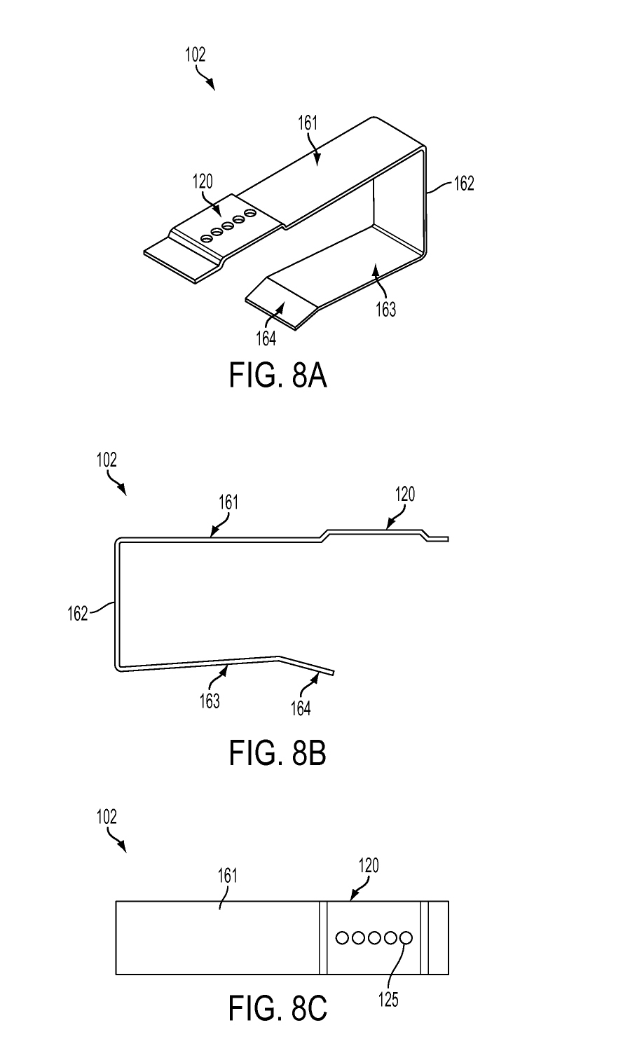

As shown in FIG. 1, the clamp assemblies 101, 102 may be slid over the thickness of the block 105, and coupled thereto by, for example, a friction fit. Those of ordinary skill in the art will realize that there are various means and methods for coupling the clamp assemblies 101, 102 to block 105, and the exemplary embodiment shown in FIG. 1 should not be considered limiting of the present invention. Although not shown in FIG. 1, either or both of the clamp assemblies 101, 102 may include wings extending therefrom to prevent movement or rotation of the clamp assembly once secured to the block 105. The clamp assemblies 101, 102 may also include portions which are serrated or rough to prevent movement or rotation of the clamp assembly on the block 105. For example, the inner surfaces of the clamp assemblies 101, 102 (which contact the block 105) may be made serrated or rough. As shown in FIGS. 7 and 8, a portion of the clamp assemblies 101, 102 (i.e., inclined portion 153 in FIG. 7; inclined portion 163 in FIG. 8) may be inclined so as to accommodate different sizes of blocks. Those of ordinary skill in the art will realize that the term “inclined” is used only for ease of reference, and that the respective portions of the clamp assemblies 101, 102 may be described in various manners (e.g., declined, tapered, etc.) all of which meaning that the width of the clamp assembly at the point of entry for the block 105 is made less than the maximum width of any block to be used in connection with the clamp system 100. Those of ordinary skill in the art will, also realize that the clamp assemblies 101, 102 may be made of a material with sufficient flexibility, such that when the clamp assemblies 101, 102 are inserted onto block 105, the inclined portions 153, 163 thereof flex outwardly to accommodate the width of the block.

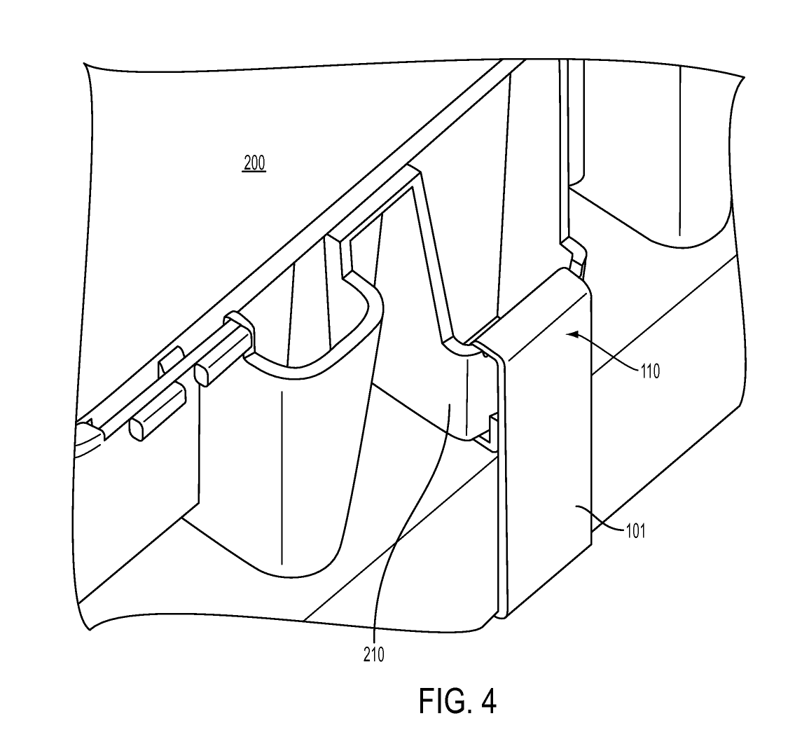

The clamp assembly 101 may include an attachment means 110, such as a wide hook, for attaching a rodent bait station (e.g., rodent bait station 200 described below) thereto. The attachment means 110 preferably extends away from the block 105 in one portion, and extends back towards the block in another portion, so as to create a C-shaped hook (as shown in FIG. 1). The attachment means 110 may be made of a height which is less than the point of attachment to the associated rodent bait station (shown in FIG. 4), so that the rodent bait station must be pressed down against the clamp assembly 102 in order to secure the attachment means. Such a configuration creates a spring pressure on the clamp assemblies 101, 102, the block 105 and the rodent device. In particular, as the rodent control device is pressed down flush on the block 105 this spring pressure will hold the station securely to the block, and prevent the clamp assemblies 101, 102 from moving on the block.

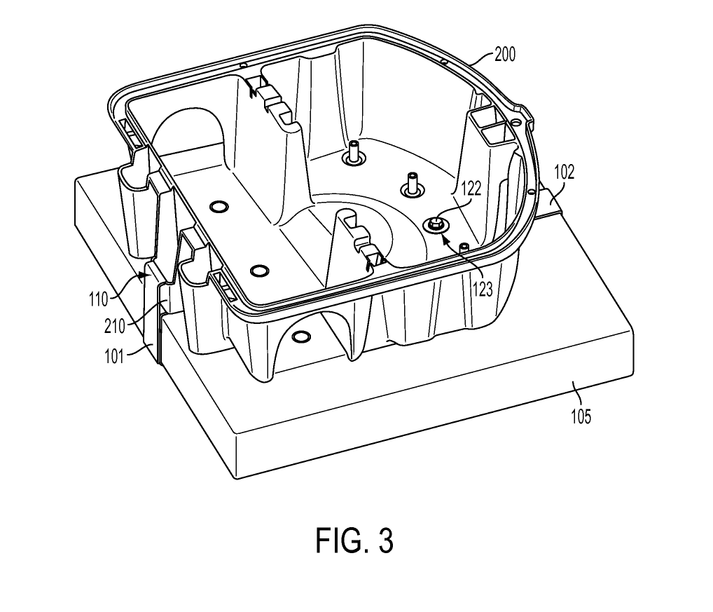

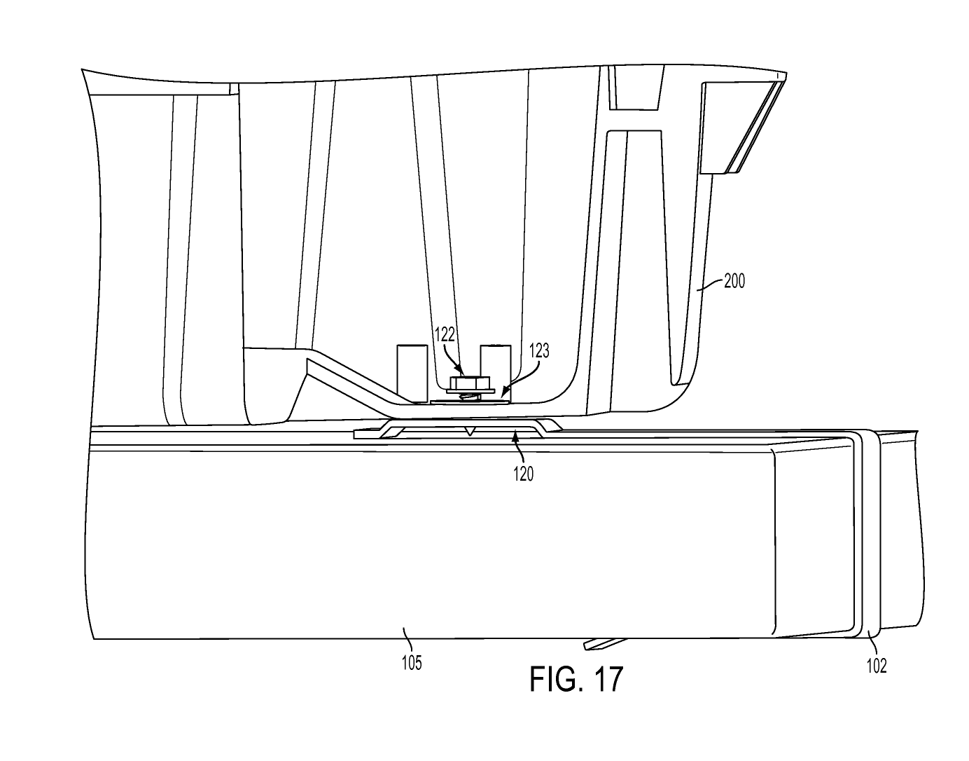

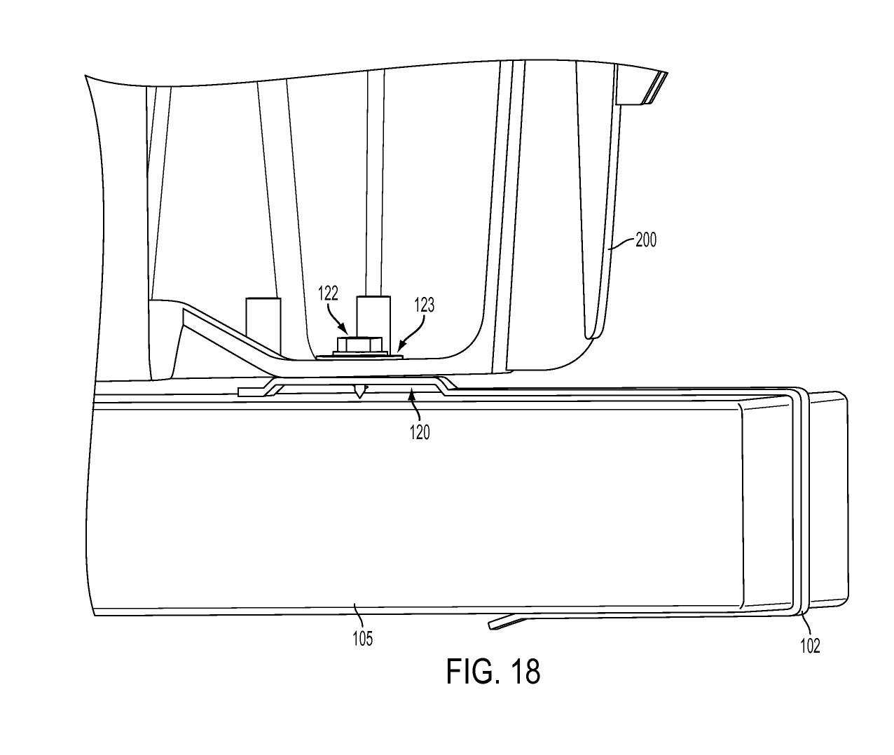

With further reference to FIG. 1, the clamp assembly 102 preferably includes a raised area 120 which may include a one or more openings 125 for receiving an attachment device 122. In the exemplary embodiment shown in FIG. 1, the attachment device 122 comprises a threaded self-tapping screw, but those of ordinary skill in the art will realize that various attachment devices may be utilized. As described below, the attachment device 122 may extend through an opening formed in the base of the rodent bait station, in order to further secure the rodent bait station to the block 105 (See FIG. 3). Additional securing means 123 (such as a washer) may also be used to ensure a good fit between the clamp assembly 102 and the rodent bait station 200. As shown in FIGS. 17 and 18, the raised area 120 may be made less in height than the length of the attachment device 122 so as to allow the screw to partially penetrate the block 105, which helps secure the rodent bait station 200 to the block. The one or more openings 125 in the raised area 120 permit different placements on the block 105, and account for variations of the size of the block.

FIG. 3 shows a rodent bait station 200 coupled to the clamp assemblies 101, 102. The exemplary rodent bait station 200 shown in FIG. 3 includes openings on opposite sides thereof to permit the ingress and egress of rodents, however, those of ordinary skill in the art will realize that the rodent bait station may have various configurations without departing from the scope of the present invention. The rodent bait station 200 may include an attachment member 210 which is adapted to couple to the attachment means 110 of the clamp assembly 101 (as shown more particularly in FIG. 4). The attachment device 122 of the clamp assembly 102 may extend through an opening in the floor of the rodent bait station 200, and then through one of the openings 125 in the clamp assembly: The additional securing means 123 may sit between the floor of the rodent bait station 200 and attachment device 122 as shown in FIG. 3.

FIG. 4 shows details of the clamp assembly 101 and the attachment means 110 in connection with the rodent bait station 200. As shown, the attachment means 110 may be coupled to an attachment member 210 which forms part of the rodent bait station 200. As noted above, the height of the attachment means 110 is preferably made less than the height of a portion of the attachment member 210 to which it attaches, so that a good spring pressure is created.

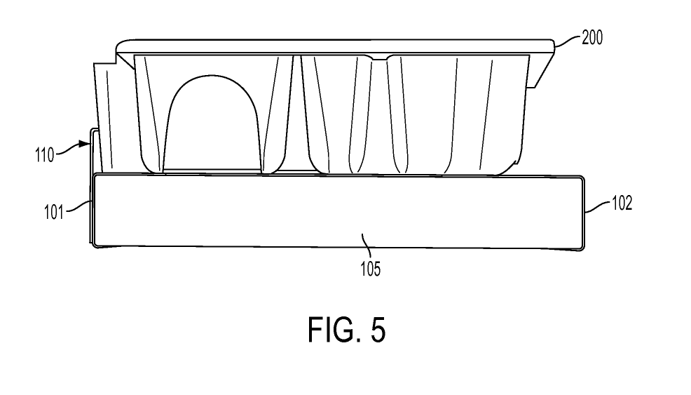

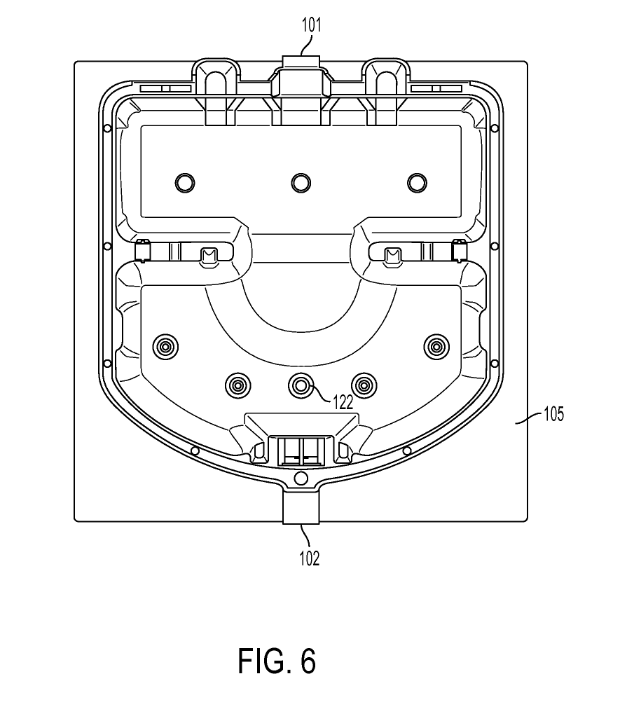

FIG. 5 shows a side view of the rodent bait station 200 coupled to the clamp assemblies 101, 102. FIG. 6 shows a top view of the rodent bait station 200 coupled to the clamp assemblies 101, 102.

FIGS. 7(a) and 7(b) show details of the clamp assembly 101. The clamp assembly 101 includes four (4) integral sections: a horizontal section 151, a vertical section 152, a first inclined section 153, and a second inclined section 154. The clamp assembly 101 is preferably made from material having some flexibility, so as to accommodate blocks 105 of differing thicknesses. As will be understood by those of ordinary skill in the art, the first inclined portion 153 may be sloped upwardly to generate a spring pressure against the block 105 when it is inserted into the clamp assembly 101. As will also be understood by those of ordinary skill in the art, the second inclined portion 154 may be sloped downwardly to allow the easy insertion of a block 105.

FIGS. 8(a), 8(b) and b(c) show details of the clamp assembly 102. The clamp assembly 102 includes five (5) integral sections: a horizontal section 161, a raised area 120 (forming part of the horizontal section 161), a vertical section 162, a first inclined section 163, and a second inclined section 164. The clamp assembly 102 is preferably made from material having some flexibility, so as to accommodate blocks 105 of differing thicknesses. As will be understood by those of ordinary skill in the art, the first inclined portion 163 may be sloped upwardly to generate a spring pressure against the block 105 when it is inserted into the clamp assembly 102. As will also be understood by those of ordinary skill in the art, the second inclined portion 164 may be sloped downwardly to allow the easy insertion of a block 105. As noted above, the raised area 120 of the clamp assembly 102 may include one or more openings 125 for receiving an attachment device 122, such as a self-tapping screw.

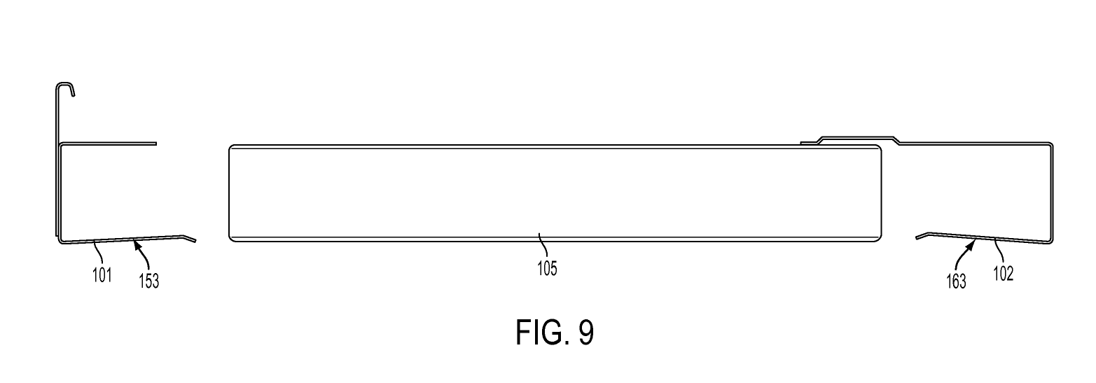

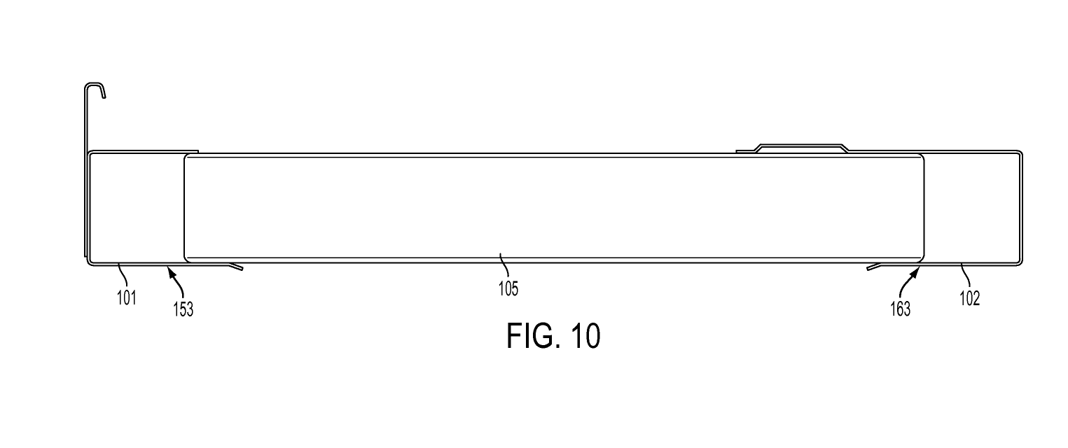

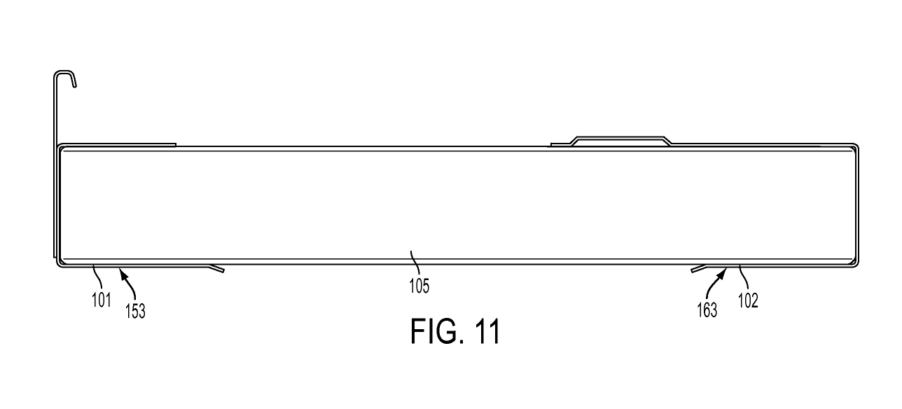

FIGS. 9-11 show how the clamp assemblies 101, 102 may be inserted into a block 105. FIG. 9 shows clamp assemblies 101, 102 in a first, partially inserted, position. FIG. 10 shows clamp assemblies 101, 102 in a second, partially inserted, position where the clamp assemblies have expanded to accommodate the width of the block 105. FIG. 11 shows clamp assemblies 101, 102 in a third, fully inserted, position.

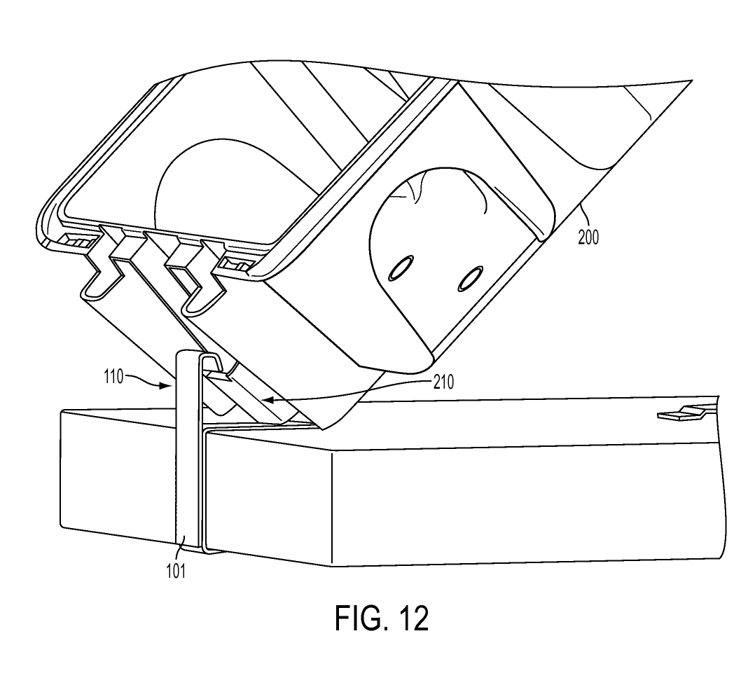

As shown in FIG. 9, the first inclined portion 153 of the clamp assembly 101 and the first inclined portion 163 of the clamp assembly 102 are inclined so that clamp assembly openings are made less than the width of the block 105. When the clamp assemblies are inserted onto the block 105 (as shown in FIG. 10), the first inclined portions 153, 163 expand outwardly to accommodate the block 105 and create a. spring pressure against the block. As noted above, this spring pressure helps to maintain the clamp assemblies 101, 102 on the block 105. FIG. 11 shows the clamp assemblies 101, 102 fully inserted onto the block 105. At this point, the rodent bait station 200 may be attached as shown in FIGS. 12-18.

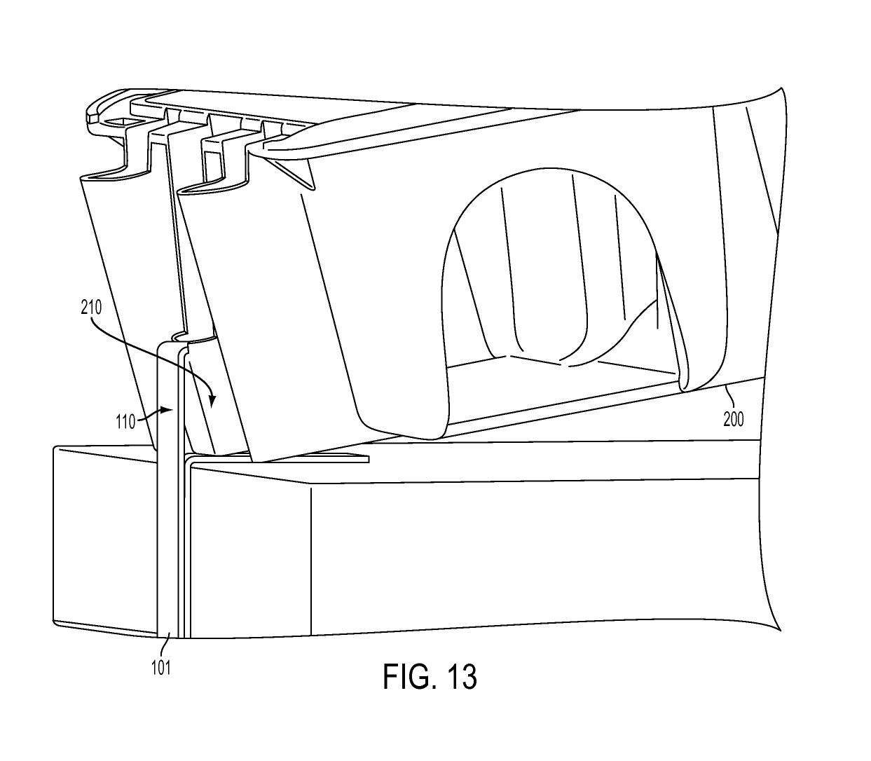

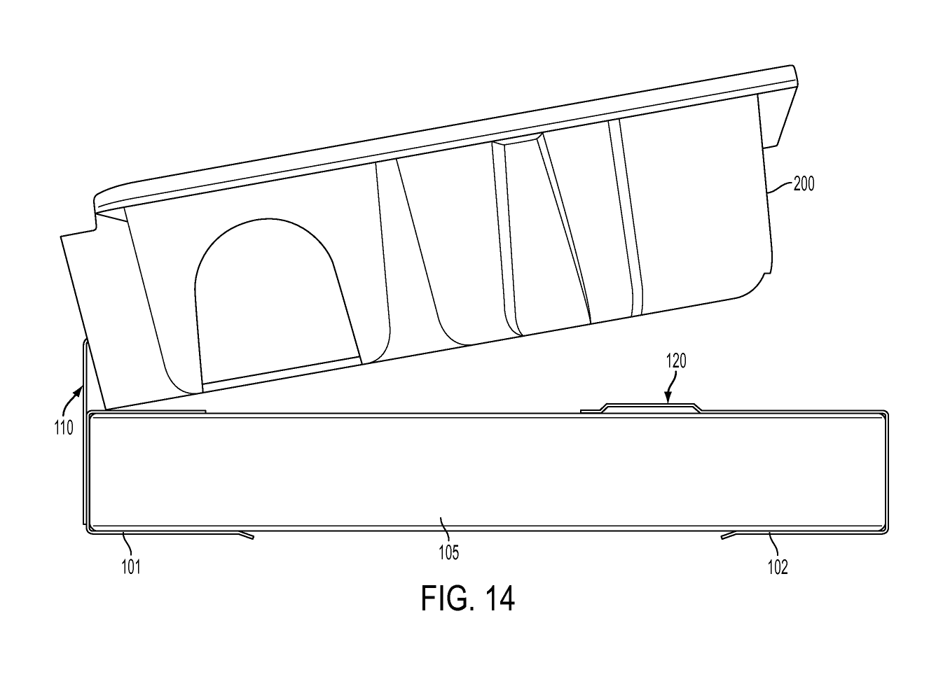

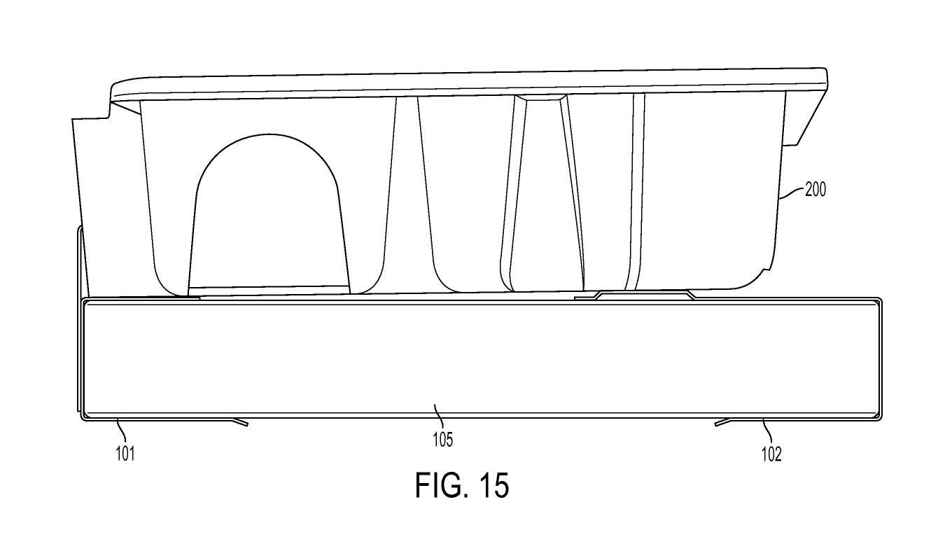

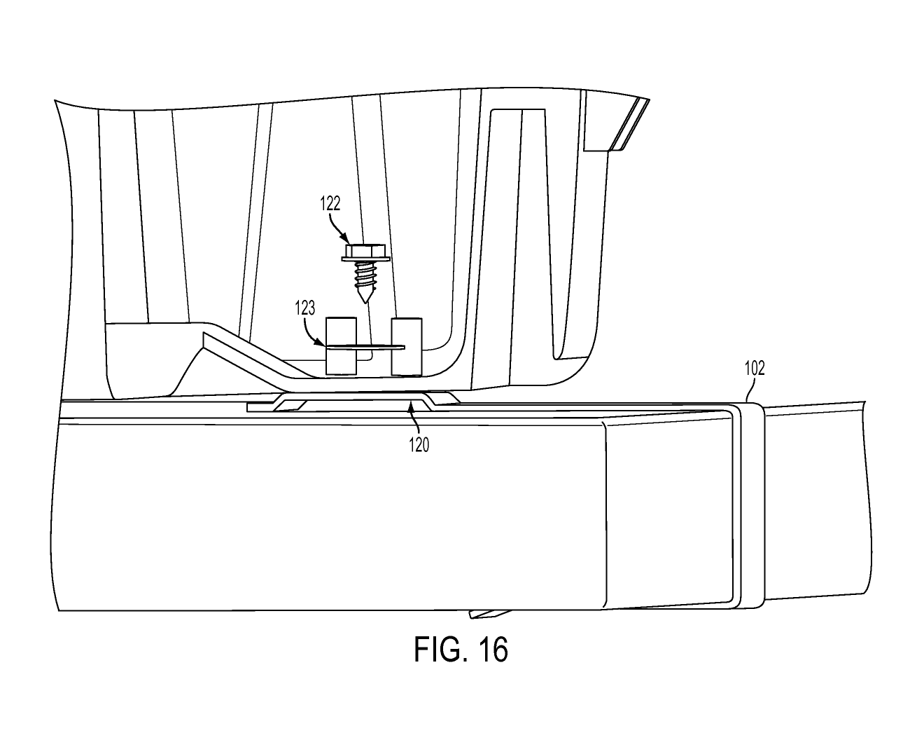

FIGS. 12-18 show how the rodent bait station 200 may be secured to the clamp system 100. FIG. 12 shows the rodent bait station 200 in a first, partially inserted, position. FIGS. 13 and 14 show the rodent bait station 200 in a second, partially inserted,. position. FIG. 15 shows the rodent bait station 200 in a third, fully inserted, position. FIGS. 16-18 show how the attachment device 122 (e.g., self-tapping screw) may be used to secure the rodent bait station to the clamp system 100, and thus to the block 105.

As shown in FIG. 12, the rodent bait station 200 is typically inserted by angling it with respect to the clamp assembly 101. In particular, the attachment member 210 of the rodent bait station 200 may be angled so that it fits underneath the attachment means 110 of the clamp assembly 101. As discussed above, the height of the attachment means 110 may be made less than the height of the attachment member 210 of the rodent bait station 200 to ensure a secure fit. In this way, when the rodent bait station 200 is rotated downward (toward the block 105), the attachment member 210 of the rodent bait station 200 becomes securely affixed to attachment means 110 of the clamp assembly 101 by friction fit. FIGS. 13 and 14 show the rodent bait station 200 rotated downward closer to the block 105, and how the attachment means 110 of the clamp assembly 101 operates to hold the attachment member 210 of the rodent bait station 200. FIG. 15 shows a fully inserted position for the rodent bait station 200. In this fully inserted position the rodent bait station 200 is securely held to the clamp system 100 even without the, use of further means (such as attachment device 122) simply due to the friction fit of the attachment means 110 of the clamp assembly 101 with the attachment member 210 of the rodent bait station 200. However, in order to make sure the rodent bait station 200 is securely held to the clamp system 100 under all conditions, an attachment device 122 is inserted through an opening in the floor of the rodent bait station 200, as shown in FIGS. 16-18.

FIG. 16 shows the attachment device 122 (e.g., self-tapping screw) and the additional securing means 123 (e.g., washer) prior to insertion into the opening in the floor of the rodent bait station 200 and through the openings 125 in the raised area 120 of the clamp assembly 102. As shown, the additional securing means 123 may be disposed between the attachment device 122 and the floor of the rodent bait station 200. FIG. 16 also shows that the raised area 120 of the clamp assembly 102 may have sufficient clearance so that the attachment device 122 may be at least partially inserted without contacting the block 105. This is a key feature as it reduces the stress on the clamp assembly 102 and the attachment device 122, and makes the process of attaching the rodent bait station 200 to the clamp system 100 easier.

FIG. 17 shows the attachment device 122 and the additional securing means 123 when partially inserted into the opening in the floor of the rodent bait station 200 and through the openings 125 in the raised area 120 of the clamp assembly 102. At this point, no portion of the attachment device 122 is in contact with the block 105 due to the clearance created by the raised area 120. However, as the attachment device 122 continues to be inserted, one end thereof may contact the block 105, as shown in FIG. 18. In the case of the exemplary attachment device 122 shown in FIGS. 16-18 (i.e., a self-tapping screw), the contact with the block 105 permits the attachment device 122 to be secured to the block 105 directly (i.e., the screw burrows into the block), thus improving the overall quality of the retention of the rodent bait station 200 to the clamp system 100.

In sum, the present invention comprises a system and method for coupling a rodent bait station to a block, pad, or other environmental object (e.g., floor, wall, etc.). In the case of a block or pad, such may comprise a concrete patio block or paver. The exemplary clamp system 100 may include one or more clamp assemblies, but is shown in the exemplary embodiment as including two clamp assemblies 101, 102. The clamp assemblies 101, 102 may be made of metal, plastic, or other suitable material. The clamp assemblies 101, 102 are preferably dimensioned so as to fit over a block or pad of standard thickness, but may be made of variable dimensions without departing from the scope of the present invention. A first portion (e.g., clamp assembly 101) of clamp system 100 may include an attachment means (e.g., attachment means 110) which may be coupled to a rodent bait station by spring-type pressure, and a second portion (e.g., clamp assembly 102) of the clamp system may include a raised area (e.g., raised area 120) for receiving an attachment device (e.g., attachment device 122) for further securing the clamp system to the rodent bait station. The first and second portions of the clamp system may be disposed on opposing sides of a rodent bait station as shown in the exemplary drawings, but such is not a requirement of the present invention. The rodent bait station may include a specific portion (e.g., attachment member 210) to which the first portion of the clamp system 100 is coupled.

Although the exemplary embodiment of the clamp system 100 is described above in connection with two separate clamp assemblies 101, 102, those of ordinary skill in the art will realize that the clamp system 100 may be formed of a single clamp assembly. Further, although an exemplary embodiment of a rodent bait station 200 is described herein, those of ordinary skill in the art will realize that various rodent bait stations and/or rodent control devices may be substituted therefore without departing from the scope of the present invention.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

1. A rodent control device comprising:
a clamp system comprised of first and second clamp assemblies; and,
a rodent bait station having at least one opening formed therein for receiving an attachment device,
wherein the first clamp assembly of the clamp system includes a raised area having one or more openings formed therein for receiving the attachment device.

2. The rodent control device of claim 1, wherein the at least one opening formed in the rodent bait station is aligned at least one of the one or more openings formed in the first clamp assembly.

3. The rodent control device of claim 1, wherein the clamp system is adapted to receive a block.

4. The rodent control device of claim 1, wherein the attachment device comprises a self-tapping screw.

5. The rodent control device of claim 1, wherein the first clamp assembly includes a first inclined section.

6. The rodent control device of claim 5, wherein the second clamp assembly includes a first inclined section.

7. The rodent control device of claim 5, wherein the first clamp assembly includes a second inclined section.

8. The rodent control device of claim 6, wherein the second clamp assembly includes a second inclined section.

9. The rodent control device of claim 1, wherein the first clamp assembly includes an attachment means.

10. The rodent control device of claim 9, wherein a height of the attachment means is made less than a height of a portion of the rodent bait station to which is attaches.

11. The rodent control device of claim 6, wherein the first inclined sections of the first and second clamp assemblies are adapted to generate a spring pressure against a block held by the clamp system.

12. The rodent control device of claim 1, wherein attachment device partially penetrates the block, helping to secure the rodent bait station to the block.

13. The rodent control device of claim 4, wherein self-tapping screw partially penetrates the block, helping to secure the rodent bait station to the block.

14. A clamp system comprising:
a first clamp assembly; and,
a second clamp assembly,
wherein the first clamp assembly includes a raised area having one or more openings formed therein for receiving an attachment device.

15. The clamp system of claim 14, wherein the first clamp assembly includes a first inclined section.

16. The clamp system of claim 15, wherein the second clamp assembly includes a first inclined section.

17. The clamp system of claim 15, wherein the first clamp assembly includes a second inclined section.

18. The clamp system of claim 16, wherein the second clamp assembly includes a second inclined section.

19. The clamp system of claim 14, wherein the first clamp assembly includes an attachment means.

20. The clamp system of claim 19, wherein a height of the attachment means is made less than a height of a first member to which is attaches.

21. The clamp system of claim 15, wherein the first inclined sections of the first and second clamp assemblies are adapted to generate a spring pressure against a block held by the clamp system.

22. The clamp system of claim 21, wherein the attachment device partially penetrates the block, helping to secure the rodent bait station to the block.

23. A method for monitoring rodent activity comprising the steps of:
attaching a clamp system to a block;
attaching the clamp system and block to a rodent bait station; and,
periodically observing the rodent bait station to determine if rodent activity has occurred.

24. The method of claim 23, wherein the clamp system comprises a first, clamp assembly and a second clamp assembly, wherein the first clamp assembly includes a raised area having one or more openings formed therein for receiving an attachment device.

25. The method of claim 23, wherein the first clamp assembly includes a first inclined section.

26. The method of claim 25, wherein the second .clamp assembly includes a first inclined section.

27. The method of claim 23, wherein the first clamp assembly includes an attachment means.

28. The method of claim 27, wherein a height of the attachment means is made less than a height of a first member to which is attaches.

29. The method of claim 26, wherein the first inclined sections of the first and second clamp assemblies are adapted to generate a spring pressure against the block.

30. The method of claim 24, wherein attachment device partially penetrates the block, helping to secure the rodent bait station to the block.
